(19) United States
(12) Patent Application Publication
(10) Pub. No.: US 2024/0396279 A1
(43) Pub. Date: Nov. 28, 2024

(54) MANUFACTURING METHOD OF BUSBAR

(71) Applicant: YAZAKI CORPORATION, Tokyo (JP)

(72) Inventors: Kenji Kajikawa, Tokyo (JP); Masaki Tanaka, Makinohara-shi (JP)

(21) Appl. No.: 18/646,763

(22) Filed: Apr. 26, 2024

(30) Foreign Application Priority Data
May 22, 2023 (JP) 2023-083980

(51) Int. Cl. H01R 43/16

(52) U.S. Cl. CPC H01R 43/16

(57) ABSTRACT

A method for manufacturing a busbar includes preparing a busbar coupling body in which a plurality of the busbars are continuously coupled by a carrier, cutting the carrier to separate the busbar from the busbar coupling body. In the cutting, an engagement protrusion is formed simultaneously with the cutting of the carrier, and the engagement protrusion is to be engaged with a connector housing when the busbar is press-fitted into the connector housing.

### CROSS-REFERENCE TO RELATED APPLICATIONS

This application is based on and claims priority under 35 USC 119 from Japanese Patent Application No. 2023-083980 filed on May 22, 2023.

### TECHNICAL FIELD

The present invention relates to a method for manufacturing a busbar.

### BACKGROUND ART

When electrically interconnecting a plurality of electric wires, a connector called a joint connector is widely used. The joint connector includes a plurality of connection terminals connected to the plurality of electric wires, respectively, and a joint busbar that short-circuits the connection terminals by being attached to a connector housing. The busbar includes a coupling portion at a rear end and a plurality of terminal portions extending forward from the coupling portion in a comb-teeth shape. By the busbar being attached to the connector housing, and the connection terminals inserted from the front of the connector housing being connected to the terminal portions of the busbar, the electric wires connected to the connection terminals are connected to each other.

As described in Patent Literature 1, this type of a busbar is formed by punching a flat metal plate with a predetermined die, and is press-fitted and fixed to the connector housing.

Patent Literature 2 discloses a technique of preparing a busbar coupling body in which a plurality of busbars are connected to a band-shaped carrier via coupling pieces, and cutting each coupling piece to separate the individual busbars from the carrier.

### CITATION LIST

### Patent Literature

Patent Literature 1: JP2014-232644A
Patent Literature 2: JP2016-9645A

### SUMMARY OF INVENTION

In the related art, as described in Patent Literature 1, when a busbar having a predetermined number of terminal portions is manufactured, a busbar body and an engagement protrusion for press-fitting and fixing the busbar body are formed using a die corresponding to the number of terminal portions required. Therefore, in the case of using busbars with different numbers of terminal portions (number of poles) to be press-fitted into the connector housing, it is necessary to prepare a die for each number of poles and punch out the busbar. Accordingly, the manufacture of busbars having a plurality of busbar patterns cannot be easily coped with.

In the technique described in Patent Literature 2, when busbars having different shapes are used, it is necessary to prepare busbar coupling bodies having shapes corresponding to the respective busbar patterns. Therefore, the manufacture of busbars with a plurality of patterns cannot be easily coped with.

The present invention has been made in view of the above circumstances, and an object of the present invention is to provide a method for manufacturing a busbar that can easily produce busbars of a plurality of patterns for press-fitting and fixing to a connector housing.

In order to achieve the object described above, the method for manufacturing a busbar according to the present invention is characterized as follows. A method for manufacturing a busbar includes preparing a busbar coupling body in which a plurality of the busbars are continuously coupled by a carrier, cutting the carrier to separate the busbar from the busbar coupling body. In the cutting, an engagement protrusion is formed simultaneously with the cutting of the carrier, and the engagement protrusion is to be engaged with a connector housing when the busbar is press-fitted into the connector housing.

According to the present invention, it is possible to easily produce busbars of a plurality of patterns for press-fitting and fixing to a connector housing.

The present invention has been briefly described above. Further, details of the present invention can be clarified by reading modes (hereinafter, referred to as “embodiments”) for carrying out the invention described below with reference to the accompanying drawings.

### BRIEF DESCRIPTION OF DRAWINGS

Exemplary embodiment of the present invention will be described in detail based on the following figures, wherein:

FIG. 1 is an exploded perspective view showing an example of a connector using a busbar manufactured by a method according to an exemplary embodiment of the present invention;

FIG. 2 is a front view of the connector;

FIG. 3 is a cross-sectional view taken along a line A-A in FIG. 2;

FIG. 4 is an enlarged view of a portion B in FIG. 3;

FIG. 5 is a diagram and a partially enlarged view illustrating a method for manufacturing a busbar according to the embodiment of the present invention; and

FIG. 6 is a plan view showing an example of a plurality of types of busbars having different numbers of poles manufactured by the method for manufacturing a busbar according to the embodiment of the present invention.

### DESCRIPTION OF EMBODIMENTS

A specific embodiment of the present invention will be described below with reference to the drawings.

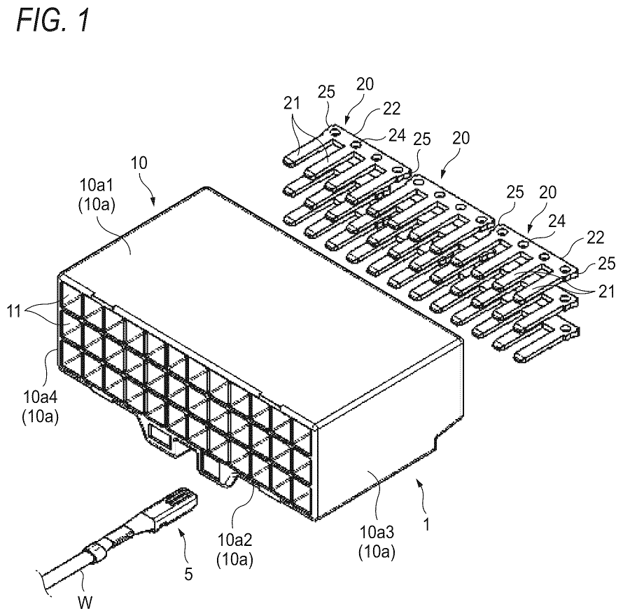

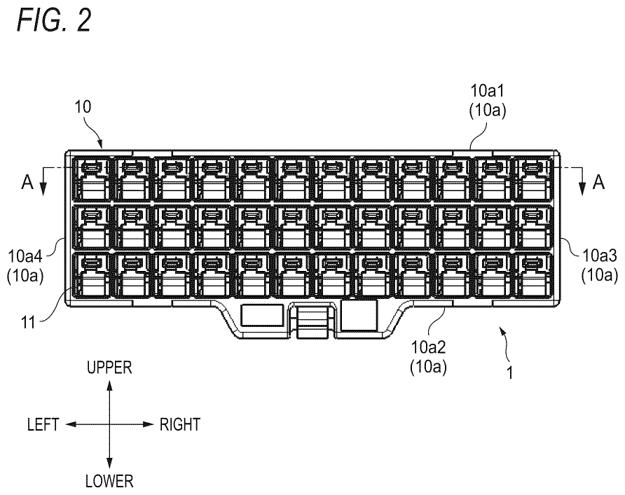

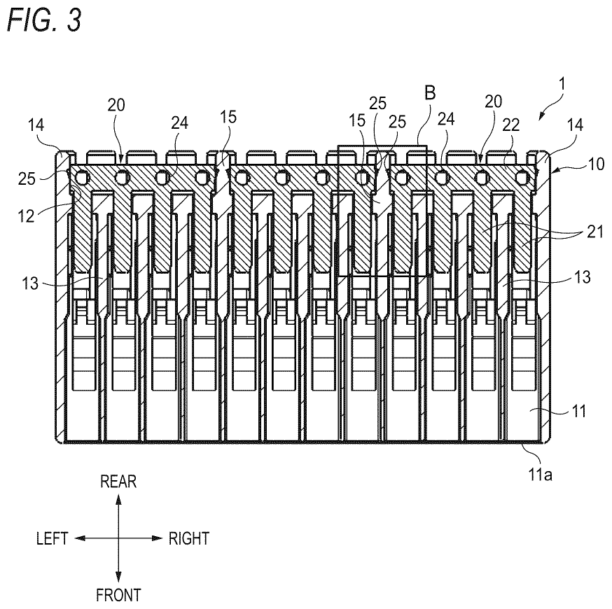

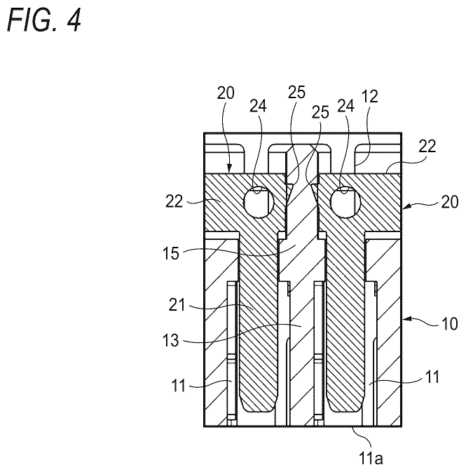

FIG. 1 is an exploded perspective view showing an example of a connector using a busbar manufactured by a method according to an embodiment of the present invention. FIG. 2 is a front view of the connector. FIG. 3 is a cross-sectional view taken along a line A-A in FIG. 2. FIG. 4 is an enlarged view of a portion B in FIG. 3. Hereinafter, for convenience of description, as shown in FIGS. 2 and 3, “upper”, “lower”, “left”, “right”, “front”, and “rear” are defined. The “upper-lower direction”, the “left-right direction”, and the “front-rear direction” are orthogonal to one another.

First, a connector and a busbar will be described.

As shown in FIG. 1, in a connector 1, a busbar 20 is to be press-fitted into a connector housing 10 from the rear, and connection terminals (counterpart terminals) 5 respectively connected to a plurality of electric wires W are inserted into terminal accommodating chambers 11 of the connector housing 10 from the front. As described above, the connector 1 is used to interconnect the plurality of connection terminals 5, that is, the electric wires W, via the busbars 20. This type of connector 1 is generally called a connector with a joint function or a joint connector.

As shown in FIGS. 1 and 2, the connector housing 10 of the connector 1 includes a peripheral wall 10a and the terminal accommodating chambers 11 provided inside the peripheral wall 10a. The peripheral wall 10a of the connector housing 10 is formed in a flat rectangular tube shape. Of pairs of opposing walls forming the peripheral wall 10a, one pair of opposing walls having a wide width is called an upper wall 10a1 and a lower wall 10a2, and the other pair of opposing walls having a narrow width is called a side wall 10a3 and a side wall 10a4. The terminal accommodating chambers 11 are arranged in the upper-lower direction and the left-right direction of the connector housing 10. In the illustrated example, twelve terminal accommodating chambers 11 arranged in a row in the left-right direction are arranged in three stages in the upper-lower direction.

As shown in FIGS. 3 and 4, each of the terminal accommodating chambers 11 is provided to penetrate from a front end to a rear end of the connector housing 10, and the terminal accommodating chambers 11 adjacent to each other in the left-right direction and the upper-lower direction are partitioned by a partition wall 13. A rear end portion of the terminal accommodating chamber 11 communicates with an accommodation recess 12 that accommodates a coupling portion 22 of the busbar 20 inserted from the rear toward the front.

The busbar 20 press-fitted into the connector housing 10 from the rear includes the coupling portion 22 at a rear end and a plurality of tab-shaped terminal portions 21 extending forward in a comb-teeth shape from the coupling portion 22 in parallel with each other. In addition, engagement protrusions 25 are respectively provided on left and right side edges of the coupling portion 22. The engagement protrusions 25 engage with the side walls 10a3 and 10a4 and partition walls 14 and 15 of the connector housing 10 when the busbar 20 is press-fitted into the connector housing 10. The partition walls 14 and 15 prevent a short circuit between adjacent busbars 20, concurrently serving as a busbar locking portion. For example, when the busbar 20 located on the leftmost side in FIG. 3 is press-fitted into the connector housing 10, the engagement protrusions 25, 25 provided on the left and right side edges of the coupling portion 22 respectively engage with the side wall 10a4 and the partition wall 15. The busbar 20 is inserted into the connector housing 10 from the rear toward the front, so that the coupling portion 22 is accommodated in the accommodation recess 12. At this time, in the busbar 20, the engagement protrusions 25 on the left and right side edges are press-fitted and fixed to the side walls 10a3 and 10a4 and the partition walls 14 and 15 in a state where each of the terminal portions 21 protrude into the terminal accommodating chambers 11.

A front end of each terminal accommodating chamber 11 is open as an insertion opening 11a for the counterpart connection terminal 5. The counterpart connection terminal 5 is electrically connected to the terminal portion 21 of the busbar 20 protruding into each terminal accommodating chamber 11. The connection terminal 5 is electrically connected to the terminal portion 21 of the busbar 20 by being inserted into each terminal accommodating chamber 11 of the connector housing 10 from the front. The connection terminal 5 is retained and locked by a flexible lance (not shown) provided in each terminal accommodating chamber 11.

The busbar 20 is formed to have a busbar pattern corresponding to a short-circuit specification of the connection terminal 5 to be inserted. In this example, as shown in FIG. 3, the busbar 20 has four terminal portions 21 protruding from the coupling portion 22 so as to short-circuit the four connection terminals 5 that are arranged adjacent to each other in the left-right direction. The positions and the number of the connection terminals 5 to be short-circuited are freely set according to the specifications of the connector 1. Therefore, the busbars 20 with busbar patterns having different numbers of terminal portions 21 are prepared according to the number of the connection terminals 5 to be short-circuited.

Next, a method for manufacturing a busbar according to the embodiment of the present invention will be described.

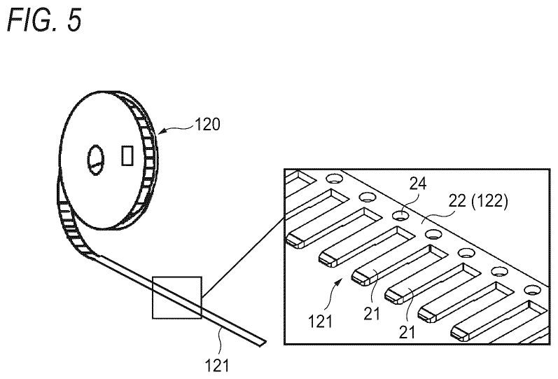

FIG. 5 is a diagram and a partially enlarged view illustrating the method for manufacturing a busbar according to the embodiment of the present invention.

The method for manufacturing a busbar according to the present embodiment allows easy manufacture of the busbar 20 having a busbar pattern with any number of terminal portions 21.

First, as described above, the busbar 20 to be manufactured includes the plurality of tab-shaped terminal portions 21 to be inserted into the terminal accommodating chambers 11 of the connector housing 10 respectively, and the coupling portion 22 in a band plate shape that couples base ends of the plurality of terminal portions 21 to each other. The coupling portion 22 hold the terminal portions 21 in a constant arrangement and in parallel to each other. Each busbar 20 is provided with the engagement protrusions 25 on the left and right side edges for engaging with the connector housing 10 when the busbar 20 is press-fitted into the connector housing 10.

In the method according to the embodiment, first, as shown in FIG. 5, a busbar coupling body 121 in which a plurality of busbars 20 are continuously coupled by a carrier 122 is prepared (preparation step). The busbar coupling body 121 is formed as a continuous supply material 120 by punching a band plate-shaped base material. The continuous supply material 120 includes the carrier 122 that also serves as the coupling portion 22 and a plurality of terminal portions 21 protruding from the carrier 122 in a comb-teeth shape, and is fed and supplied in a state of being wound in a roll shape. Pitch holes 24 are provided in the carrier 122 of the busbar coupling body 121 for the feeding operation and the management of a feeding pitch. Then, the carrier 122 of the fed busbar coupling body 121 is cut by punching in a next cutting step, thereby separating the busbar 20 from the busbar coupling body 121. In the cutting step, the engagement protrusions 25 are formed simultaneously with the cutting of the carrier 122.

Since a cutting position of the carrier 122 of the busbar coupling body 121 can be freely set, by cutting the carrier 122 at any position, the busbar 20 of any size, that is, a busbar pattern having any number of terminal portions 21 can be obtained.

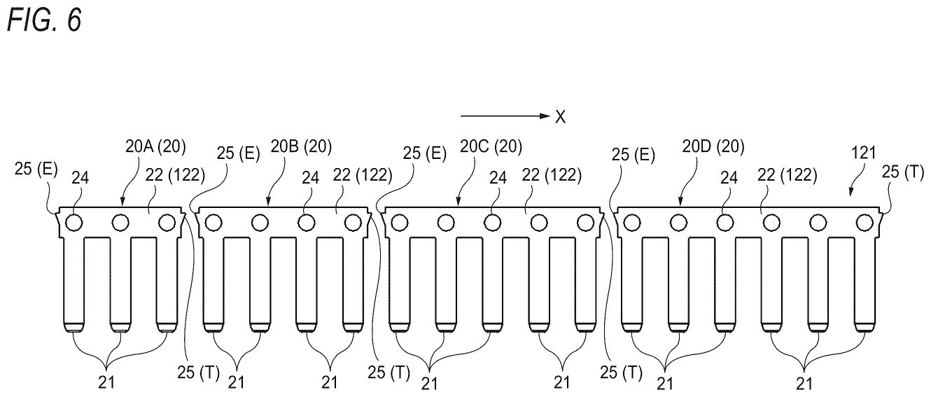

FIG. 6 is a plan view showing an example of a plurality of types of busbars having different numbers of poles manufactured by the method for manufacturing a busbar according to the embodiment of the present invention. In FIG. 6, for example, the busbar coupling body 121 is sequentially fed and moved in the direction of an arrow X.

As shown in FIG. 6, when the busbar 20 at a front stage is separated from the busbar 20 at a rear stage, the engagement protrusions 25, 25 are simultaneously punched out and formed on a rear end E of the carrier 122, which will become the coupling portion 22 of the busbar 20 at the front stage, and a front end T of the carrier 122, which will become the coupling portion 22 of the busbar 20 at the rear stage.

In FIG. 6, busbars 20A, 20B, 20C, and 20D having four busbar patterns with three, four, five, and six poles (terminal portions 21) are shown. According to the method for manufacturing a busbar of the present embodiment, the cutting position of the carrier 122 of the busbar coupling body 121 is freely selected, so that the busbars 20 (20A to 20D) having the engagement protrusions 25, 25 and having any size that is, busbar patterns with different numbers of poles can be freely manufactured. According to the method for manufacturing a busbar of the present embodiment, for example, after manufacturing a predetermined number of busbars 20A having the same shape from the busbar coupling body 121 of one product number, busbars 20B having different patterns can be successively manufactured. In this way, it is possible to easily cope with a plurality of busbar patterns by simply supplying the busbar coupling body 121 of one product number.

The present invention is not limited to the above-described embodiment, and can be appropriately modified, improved, or the like. In addition, the material, shape, size, numerical value, form, number, arrangement position, and the like of components in the above-described embodiment are freely selected and are not limited as long as the present invention can be achieved. For example, although the number of poles of the busbar 20 is three, four, five, or six in the above embodiment, the number of poles may be one or more. In the above embodiment, an example has been shown in which the busbar 20 is used in the connector 1 with a joint function, but a busbar manufactured by the method for manufacturing a busbar according to the present invention can be used in various connectors.

Here, features of the method for manufacturing a busbar according to the embodiment of the present invention described above are briefly summarized and listed in the following [1] to [3]. [1] A method for manufacturing a busbar (20), the method comprising:
preparing a busbar coupling body (121) in which a plurality of the busbars are continuously coupled by a carrier (122); and
cutting the carrier to separate the busbar from the busbar coupling body,
wherein in the cutting, an engagement protrusion (25) is formed simultaneously with the cutting of the carrier; and
the engagement protrusion is to be engaged with a connector housing (10) when the busbar is press-fitted into the connector housing.

According to the configuration of [1], by cutting the carrier (122) of the busbar coupling body (121), the engagement protrusions (25) to be engaged with the connector housing can be simultaneously formed, and the busbar (20) having the engagement protrusions (25) can be obtained. Thus, by changing the cutting position of the carrier (122), busbars (20) of a plurality of patterns can be obtained. Therefore, it is possible to easily cope with a plurality of busbar patterns by simply supplying the busbar coupling body (121) of one product number, and changing the cutting position of the carrier (122).

[2] In the method according to [1],
the busbar (20) includes a plurality of tab-shaped terminal portions (21) to be inserted into terminal accommodating chambers (11) of the connector housing (10) respectively, and a coupling portion (22) in a band plate shape that couples base ends of the plurality of terminal portions to each other and holds each of the terminal portions in a constant arrangement and in parallel to each other, and
the busbar coupling body (121) is a continuous supply material (120) including the carrier (122) concurrently serving as the coupling portion (22), and a plurality of the terminal portions (21) protruding from the carrier in a comb-teeth shape.

According to the configuration of [2], by cutting the carrier (122) in the cutting step, it is possible to obtain the busbar (20) having the engagement protrusion (25) and having any size, that is, any number of terminal portions (21) (number of poles) and coupling portions (22).

[3] In the method for manufacturing a busbar according to [2],
the continuous supply material (120) is fed and supplied in the cutting step in a state of being wound in a roll shape.

According to the configuration of [3], the busbar coupling body (121) can be introduced into the cutting step by being fed out from the roll.

What is claimed is:

1. A method for manufacturing a busbar, the method comprising:
preparing a busbar coupling body in which a plurality of the busbars are continuously coupled by a carrier; and
cutting the carrier to separate the busbar from the busbar coupling body,
wherein in the cutting, an engagement protrusion is formed simultaneously with the cutting of the carrier; and
the engagement protrusion is to be engaged with a connector housing when the busbar is press-fitted into the connector housing.

2. The method according to claim 1,
wherein the busbar includes a plurality of tab-shaped terminal portions to be inserted into terminal accommodating chambers of the connector housing respectively, and a coupling portion in a band plate shape that couples base ends of the plurality of terminal portions to each other and holds each of the terminal portions in a constant arrangement and in parallel to each other, and
wherein the busbar coupling body is a continuous supply material including the carrier concurrently serving as the coupling portion, and a plurality of the terminal portions protruding from the carrier in a comb-teeth shape.

3. The method according to claim 2,
wherein the continuous supply material is fed and supplied in the cutting in a state of being wound in a roll shape.
